(19) United States
(12) Patent Application Publication
(10) Pub. No.: US 2007/0236396 A1
(43) Pub. Date: Oct. 11, 2007

(54) Antenna structure

(75) Inventor: Yan-Ping Gao, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/599,989

(22) Filed: Nov. 16, 2006

(30) Foreign Application Priority Data
Apr. 6, 2006 (TW) 095205751

(51) Int. Cl. H01Q 1/24

(52) U.S. Cl. 343/702; 343/700 MS

(57) ABSTRACT

The present invention is to provide an antenna structure comprising a dielectric substrate and a transmitting portion provided on one surface of the dielectric substrate, wherein the transmitting portion has one end formed with first and second radiators and the other end bent toward the other surface of the dielectric substrate, the first radiator has one end coupled to the transmitting portion and the other end extended away from the transmitting portion for receiving signals of a first operating frequency, and the second radiator has one end coupled to a joining portion of the first radiator and the transmitting portion and the other end extended around one end of the first radiator and is spaced from the first radiator by a gap for receiving signals of a second operating frequency. Thus, the antenna structure is capable of receiving signals of two different operating frequencies.

### FIELD OF THE INVENTION

The present invention relates to an antenna structure, and more particularly to a compact antenna structure mounted in a mobile phone for receiving signals of two different operating frequencies.

### BACKGROUND OF THE INVENTION

The world has entered into a new era with both information technology and electronics being progressed rapidly. Many advanced products including mobile communications devices are commercially available due to the fast progress in computer technology, telecommunications technology, and network technology. These products are featured with compact size, multi-function, and low price due to mass production. Thus, it is gaining popularity among people. One popular kind of such products is mobile phone. Nowadays, mobile phones are closely tied to our daily life and work. Further, mobile phones shorten time to communicate people located at different places having a long distance therebetween. In another aspect, more advanced mobile phones are developed as time evolves. In addition, people have an increasing demand to the features and quality of the mobile phones. Thus, whether communications products (e.g., mobile phones) be produced capable of providing more convenient and powerful features will be an indicator to decide whether manufacturing technology owned by the manufacture of the communications products is more advanced than other competitive ones.

Typically, mobile phones have different frequencies each for performing a specific function as employed in different wireless communications systems. Currently, GSM (Global Standard for Mobile Communications) is widely employed throughout the world. For GSM, frequency bands including 850 MHz, 900 MHz, 1800 MHz, and 1900 MHz are employed. Typically, one mobile phone can be used in a single country only rather in two different countries because different countries may adopt different frequencies in their respective wireless communications systems. For example, 850 MHz and 1900 MHz bands are employed by GSM in U.S., 900 MHz and 1800 MHz bands are employed by GSM in Europe, and 900 MHz and 1800 MHz bands are employed by GSM in Australia, and southeastern Asia countries respectively.

A mobile phone is thus required to tune in order to be used in different countries adopting different frequencies in their respective wireless communications systems. Such mobile phones are classified as single-frequency mobile phones and are gradually phased out. In this regard, a single-frequency antenna mounted on a GSM-based mobile phone is gradually replaced by an antenna capable of supporting dual-frequency mobile communications. The dual-frequency antenna is required in its initial design. However, the dual-frequency antenna will inhibit an antenna from being designed as a compact one. Further, it can cause inconvenience in carrying a mobile phone. Furthermore, it is not aesthetic in the mobile phone's appearance.

Concealed antennas are proposed so as to decrease the size of a mobile phone and preserve the mobile phone's appearance. One popular type of concealed antenna is called planar inverted-F antenna (PIFA). PIFA has the advantages of having a simple structure and being easy in design. However, PIFA only has a single operating frequency. Accordingly, PIFA cannot be employed as a standard component of a dual-frequency mobile phone. For overcoming this drawback, a kind of PIFA for dual-frequency is developed by some manufacturers of the mobile phone. A mobile phone equipped with a PIFA for dual-frequency is capable of transmitting or receiving signals having a frequency of 900 MHz or 1800 MHz.

The PIFA for dual-frequency is made longer as compared with the typical PIFA for receiving signals of a single band. However, it undesirably increases the size and the length of PIFA for dual-frequency. Moreover, it compromises compactness of the mobile phone and occupied precious space originally reserved for electronic components of the mobile phone. In short, its long and large size contradicts the trend of compactness of mobile phone in the market. Thus, it is desirable among manufacturers of the mobile phone to provide a mobile phone having a compact antenna capable of receiving signals of either band in order to overcome the inadequacies of the prior art.

### SUMMARY OF THE INVENTION

After considerable research and experimentation, an antenna structure according to the present invention has been devised so as to overcome the above drawbacks (e.g., size and length of antenna being significant increase due to increased band coverage) of the prior art.

It is an object of the present invention to provide an antenna structure mounted in an electronic device. The antenna structure comprises a dielectric substrate and a transmitting portion provided on one surface of the dielectric substrate. The transmitting portion is disposed adjacent to a lateral side of the dielectric substrate and is served as a signal feeder. One end of the transmitting portion is formed with first and second radiators. Both the first and second radiators are provided on one surface of the dielectric substrate. The other end of the transmitting portion is bent toward the other surface of the dielectric substrate. One end of the first radiator is coupled to the transmitting portion. The other end of the first radiator is extended away from the transmitting portion. Thus, the first radiator is adapted to receive signals of a first operating frequency. The second radiator is provided around a periphery of the first radiator. One end of the second radiator is coupled to a joining portion of the first radiator and the transmitting portion. The other end of the second radiator is extended around the other end of the first radiator and is spaced from the first radiator by a gap. Further, the other end of the second radiator is extended toward the transmitting portion after passing the other end of the first radiator. Finally, the other end of the second radiator is terminated at a position spaced from the transmitting portion by a distance. Thus, the second radiator is adapted to receive signals of a second operating frequency. By configuring as above, the antenna structure is capable of receiving signals of two different operating frequencies.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of antenna structure according to the present invention; and

FIG. 2 is a schematic representation of return losses versus operating frequencies when the antenna structure is operating.

### DETAILED DESCRIPTION OF THE PREFERRED EMBODIMENTS

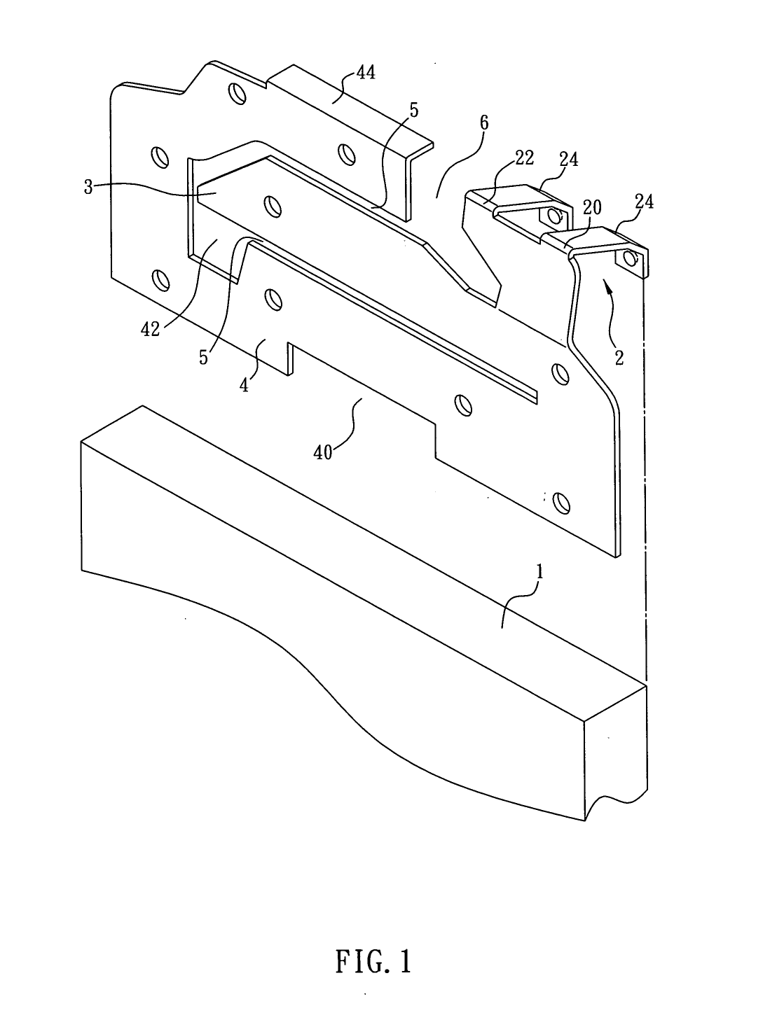

Referring to FIG. 1, an antenna structure in accordance with a preferred embodiment of the present invention is shown. The antenna structure is mounted in an electronic communications device. The antenna structure comprises a dielectric substrate 1, a transmitting portion 2, a first radiator 3, and a second radiator 4. Each component is discussed in detailed below.

The transmitting portion 2 is provided on one surface of the dielectric substrate 1 and is adjacent to and along a lateral side of the dielectric substrate 1 served as a signal feeder of the antenna structure. One end of the transmitting portion 2 is formed connecting with first and second radiators 3, 4, and the other end of the transmitting portion 2 is bent across the lateral side and toward the other surface of the dielectric substrate 1. The first radiator 3 is provided on one surface of the dielectric substrate 1, which is the same surface of the transmitting portion 2 provided thereon. The first radiator 3 has one end coupled to the transmitting portion 2, and the other end extended away from the transmitting portion 2. Thus, the first radiator 3 is adapted to receive signals of a first operating frequency. The second radiator 4 is provided around a periphery of the first radiator 3, and has one end coupled to a joining portion of the first radiator 3 and the transmitting portion 2 and the other end extended around the other end of the first radiator 3 and spaced from the first radiator 3 by a gap 5. Further, the other end of the second radiator 4 is extended back toward the transmitting portion 2 after surrounding the other end of the first radiator 3. Finally, the other end of the second radiator 4 is terminated at a position spaced from the transmitting portion 2 by a distance 6. Thus, the second radiator 4 is adapted to receive signals of a second operating frequency.

By configuring as above, the first radiator 3 and the second radiator 4 have different lengths. The first radiator 3 is adapted to receive signals of a first operating frequency and the second radiator 4 is adapted to receive signals of a second operating frequency respectively. Further, the undesired increases of length and size of the antenna structure are eliminated due to the provision of the second radiator 4 around the first radiator 3. As an end, the antenna structure is adapted to mount in a compact mobile phone.

Referring to FIG. 1 again, another preferred embodiment of the present invention is shown. The transmitting portion 2 comprises a signal transmitting terminal 20 and a ground terminal 22 both adjacent to and along the lateral side of the dielectric substrate 1. The ground terminal 22 is provided at one end of the transmitting portion 2 and is adjacent to and along the lateral side of the dielectric substrate 1. The signal transmitting terminal 20 is provided at the other end of the transmitting portion 2 and is adjacent to and along the lateral side of the dielectric substrate 1. Either first or second operating frequency is adapted to transmit through the signal transmitting terminal 20. Further, the first radiator 3 and the second radiator 4 are interconnected to the transmitting portion 2 in parallel. Thus, a reactance compensation configuration is formed by the signal transmitting terminal 20 and the ground terminal 22. Two locations of resonance frequency are formed on the antenna structure. As a result, the antenna structure is capable of receiving signals of a first operating frequency and signals of a second operating frequency different from the first operating frequency.

Referring to FIG. 1 again, a further preferred embodiment of the present invention is shown. The signal transmitting terminal 20 and the ground terminal 22 are spaced apart. A fine adjustment of the locations of resonance frequency of the antenna structure can be made by adjusting the distance between the signal transmitting terminal 20 and the ground terminal 22 until a required bandwidth is obtained. For example, the antenna structure operates in 2.45 GHz band stipulated in IEEE 802.11b protocol when the signal transmitting terminal 20 is spaced from the ground terminal 22 by the distance as envisaged by the present invention. The band covers a range from about 2.35 GHz to about 2.53 GHz and has a center operating frequency of about 2.45 GHz as proven by experiment.

Referring to FIG. 1 again, the further preferred embodiment of the present invention is shown. As stated above, two locations of resonance frequency are formed on the antenna structure. As a result, the antenna structure is capable of receiving signals of different operating frequencies. Each of the first radiator 3 and the second radiator 4 further comprises the following shapes and components. The one end of the first radiator 3 adjoined the lateral side of the transmitting portion 2 is shaped as an inverted antler. The second radiator 4 further comprises a first indentation 40, a second indentation 42, and a bent section 44. The first indentation 40 is provided adjacent to the one end of the second radiator 4 and is provided on an edge of the second radiator 4 opposite the first radiator 3. The second indentation 42 is provided between two ends of the second radiator 4 and is provided on the other edge of the second radiator 4 adjacent to the other end of the first radiator 3. The bent section 44 is provided adjacent to the other end of the second radiator 4 and is opposite to one edge of the first radiator 3 (i.e., the edge adjacent the second indentation 42). The bent section 44 is bent toward a surface on the lateral side of the dielectric substrate 1.

Referring to FIG. 1 again, the further preferred embodiment of the present invention is shown. The other end of the transmitting portion 2 is comprised of two spaced connecting members 24 each having one end interconnected the signal transmitting terminal 20 and the ground terminal 22 and the other end bent toward the other surface of the dielectric substrate 1 and electrically coupled to a circuit board (not shown) mounted in the electronic communications device. Hence, the transmitting portion 2 is adapted to transmit signals of a first operating frequency and signals of a second operating frequency different from the first operating frequency. As an end, the antenna structure is adapted to receive signals of different frequencies.

Referring to FIG. 1 again, the further preferred embodiment of the present invention is shown. The connecting members 24 are parallel so as not to adversely affect the locations of resonance frequency. The other end of either connecting member 24 is arc shaped. Thus, the antenna structure and the circuit board can be securely coupled together when the other ends of the two connecting members 24 are coupled to the circuit board.

Referring to FIG. 1 again, the further preferred embodiment of the present invention is shown. Each of the transmitting portion 2, the first radiator 3, and the second radiator 4 is formed of brown copper or white copper. Further, gold can be plated on a surface of each of the transmitting portion 2, the first radiator 3, and the second radiator 4 so as to increase electrical conductance of each of the transmitting portion 2, the first radiator 3, and the second radiator 4 respectively. It is envisaged by the present invention that the antenna structure has a shorter length and a smaller size as compared with the well known antenna structure. Further, the antenna structure of the present invention has lower manufacturing cost and thus is applicable in one of a variety of electronic communications devices.

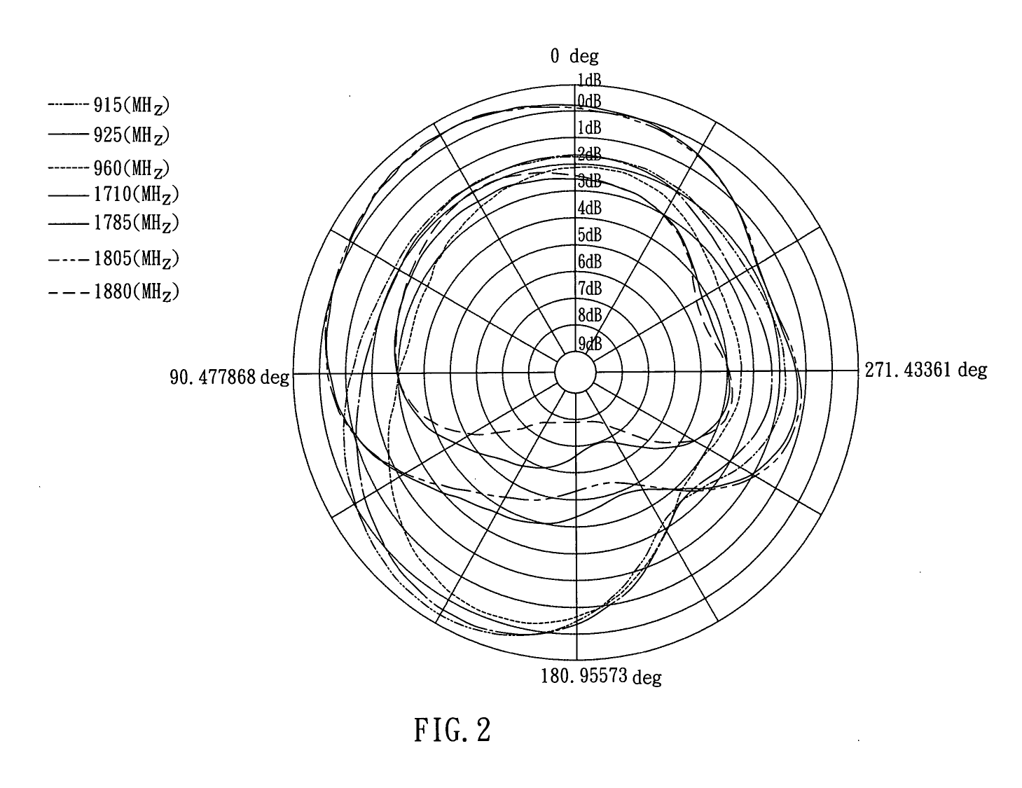

Referring to FIG. 2, it shows return losses versus operating frequencies when the antenna structure of the present invention is operating in a band ranged from 800 MHz to 1800 MHz. It is found from the measurement that the antenna structure of the present invention is capable of receiving signals of two different operating frequencies.

The present invention has been shown and described in detail, various modifications and improvements thereof will become readily apparent to those skilled in the art. Accordingly, the spirit and scope of the present invention is to be construed broadly and limited only by the appended claims and not by the foregoing specification.

What is claimed is:

1. An antenna structure mounted in an electronic device, comprising:
a dielectric substrate;
a transmitting portion disposed on one surface of the dielectric substrate, having one end adjacent to a lateral side of the dielectric substrate and served as a signal feeder, and having the other end bent toward the other surface of the dielectric substrate;
a first radiator disposed on one surface of the dielectric substrate, the first radiator having one end coupled to the transmitting portion and the other end extended away from the transmitting portion such that the first radiator is adapted to receive signals of a first operating frequency; and
a second radiator disposed around a periphery of the first radiator, the second radiator having one end coupled to a joining portion of the first radiator and the transmitting portion, and the other end extended around the other end of the first radiator and spaced from the first radiator by a gap wherein the other end of the second radiator is further extended back toward the transmitting portion after surrounding the other end of the first radiator so as to terminate at a position spaced from the transmitting portion by a distance, and the second radiator is adapted to receive signals of a second operating frequency.

2. The antenna structure of claim 1, wherein the transmitting portion comprises:
a ground terminal disposed adjacent to the lateral side of the dielectric substrate and at one side of the one end of the transmitting portion; and
a signal transmitting terminal disposed adjacent to the lateral side of the dielectric substrate and at the other side of the one end of the transmitting portion such that either the first or the second operating frequency is adapted to transmit through the signal transmitting terminal.

3. The antenna structure of claim 1, wherein the other end of the first radiator adjoined the lateral side of the transmitting portion is shaped as an inverted antler.

4. The antenna structure of claim 3, wherein the second radiator comprises:
a first indentation disposed adjacent to the one end of the second radiator and on one edge of the second radiator opposite the first radiator;
a second indentation disposed between two ends of the second radiator and on the other edge of the second radiator adjacent to the other end of the first radiator; and
a bent section disposed adjacent to the other end of the second radiator and being opposite to one edge of the first radiator adjacent the second indentation wherein the bent section is bent toward a surface adjacent the lateral side of the dielectric substrate.

5. The antenna structure of claim 4, further comprising two spaced connecting members each having one end interconnected the signal transmitting terminal and the ground terminal and the other end bent toward the other surface of the dielectric substrate and electrically coupled to a circuit board mounted in the electronic device such that the transmitting portion is adapted to transmit the signals of a first operating frequency or the signals of a second operating frequency.

6. The antenna structure of claim 5, wherein the signal transmitting terminal is spaced from the ground terminal by a distance so as to ensure a band of the antenna structure to cover a range from about 2.35 GHz to about 2.53 GHz and the band of the antenna structure to have a center operating frequency of about 2.45 GHz.

7. The antenna structure of claim 5, wherein the connecting members are parallel, and wherein one connecting member is spaced from the other connecting member by an interval.

8. The antenna structure of claim 5, wherein the other end of either connecting member is arc shaped.

9. The antenna structure of claim 5, wherein the first operating frequency is different from the second operating frequency.

10. The antenna structure of claim 5, wherein each of the transmitting portion, the first radiator, and the second radiator is formed of brown copper.

11. The antenna structure of claim 5, wherein each of the transmitting portion, the first radiator, and the second radiator is formed of white copper.

12. The antenna structure of claim 5, wherein each of the transmitting portion, the first radiator, and the second radiator has gold plated on its surface.
